(19) United States
(12) Patent Application Publication
(10) Pub. No.: US 2006/0289579 A1
(43) Pub. Date: Dec. 28, 2006

(54) Adjustable hitch mounted bicycle stand and method of using the same

(75) Inventor: Timothy A. Haskew, Northport, AL (US)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: THE UNIVERSITY OF ALABAMA, Tuscaloosa, AL (US)

(21) Appl. No.: 11/097,173

(22) Filed: Apr. 4, 2005

(51) Int. Cl. B60R 9/00; B60R 11/00

(52) U.S. Cl. 224/519; 224/924

(57) ABSTRACT

A hitch-mounted bicycle stand includes a base member, a distal end of which is configured to be securely mounted to a hitch of a vehicle, while its proximal end is adapted to receive at least two vertically extending members to form a slot to receive a portion of a bicycle tire for support. The height of the base member with respect to the ground is adjustable and several extension members, each having vertically extending members forming slots, may be connected to the base member in order to increase the number of slots for a given hitch. The stand can also be adapted to be connected to a hitch-mounted transportation device already installed in the hitch of the automobile. A method for standing a bicycle next to a vehicle is also within the scope of the instant invention.

### BACKGROUND OF THE INVENTION

1. Field of the Invention

The present invention relates generally to bicycle racks, or stands, and, more particularly, to an adjustable bicycle stand mounted on a vehicle trailer hitch.

2. Description of the Related Art

Bicycling is an old sport that has recently gained renewed interest and popularity and continues to grow, among other reasons, for its obvious health benefits. In view of this growth, many bicycling clubs have been formed and communities and local government have worked together to create safe areas for bicyclist. Because most bicycling areas are not near one's home, the bicycles have to be transported from home to favorite riding areas or to racing competitions. A large number of hitch-mounted bicycle transportation devices exists on the market designed to facilitate carrying the bicycles on cars from one point to another. It is not atypical that several bicycles are transported in a single vehicle, for example, for family entertainment or for participation in a group competition. However, upon arrival at a desired destination, none of these transportation devices provides a way to stand fully assembled bicycles near the transporting vehicle without blocking doors and tail gates or without an increased risk of damage to the bikes from accidental knockdowns.

For example, U.S. Pat. No. 6,491,195, issued on Dec. 10, 2002, discloses a bicycle modular carrier structure having an extension support that forms a trailer hitch connection having a set of holes sized to receive a clevis pin for locking one end of the extension support to a vehicle trailer hitch, following a telescopic insertion. At the other end of the extension support, a side rail is provided extending to opposite sides of the extension support. For transportation, a bicycle is placed on top of the side rail and secured at three locations. The first is a hold down device rapped around one of the bicycle tires at one end of the side rail. The second is another hold down device at the end of a vertically extending extension pole attached to a side rail rapped around a sloped frame bar of the bicycle. The third is a tire cradle assembly disposed at the other end of the side rail in which the other bicycle tire is inserted.

Another example of a bicycle rack mounted to a vehicle trailer hitch sleeve is the device disclosed in U.S. Pat. No. 6,460,745, issued on Oct. 8, 2002. This device is disclosed capable of supporting a bicycle in an upward vertical position at the rear end of a vehicle and comprises a tongue, whose proximal end is fixed to a vehicle trailer hitch sleeve via multiple transverse bores. A pair of pivoting triangular brackets, having a right angled handle bar supporting member, is attached to the distal end of the tongue and an upright member is bolted to the triangular brackets, extending vertically. In use, a bicycle is loaded on the handle bar support member by inverting the bike and placing the bicycle handlebars on the supporting member. A frame member of the bicycle is then engaged with a U-bolt and the leg of the U-bolt is threaded through bores in the upright member and locked. If trunk access is needed, a lock pin preventing the triangular brackets from pivoting is removed and the upright member is pivoted to move the bicycle away from the trunk. The bicycle is removed from rack by first removing the lock tube and the U-bolt to release the bicycle frame from the rack. Use of this bicycle rack does not require the bicycle to be disassembled.

Several other examples of hitch mounted bicycle devices exists in the prior art. For example, in the vehicle rack system of Veenen, U.S. Pat. No. 6,164,508, issued on Dec. 26, 2000, a hitch-mounted rack assembly is attached to inner and outer swing arms. When base and rack members are locked together, the rack assembly is securely located immediately above and behind the vehicle hitch receiver. When the rack member is unlocked from the base member, the rack assembly may be moved within a movement area defined by the rear of the vehicle and a horizontal, generally circular arc, that extends from one side of the vehicle to the other. U.S. Pat. No. 5,871,131, issued on Feb. 16, 1999, discloses a hitch-mounted bicycle rack for supporting bicycles in an upward standing position at the back end of a vehicle. Horizontal trays receive a portion of the rear wheel of a bicycle so as to cradle the wheel and support the bicycle. Bicycles stand upwardly from the rear wheel support trays angled from the base of a vertical support post at the rear of the vehicle. U.S. Pat. No. 5,520,315, issued on May 28, 1996 to Graham, discloses a hitch-mounted bike rack apparatus that includes a channel for receiving the wheels of a bicycle and supporting the weight of the bicycle. The channel is supported on the automobile, preferably by a male hitch member sized to fit in a female hitch member of the automobile, and includes a pair of clamps for stabilizing the apparatus on the automobile. The apparatus also includes a shackle assembly for holding a bicycle in an upright position on the channel and restraining movement of the bicycle relative to the channel.

Although the above-summarized patents disclose hitch-mounted bicycle devices to transport assembled, or most often, disassembled bicycles, none provide for a simple way to hold single or multiple fully assembled bicycles upright next to a vehicle with minimum blockage to doors, trunks, and tailgates. At most cycling events, and particularly in races, teams travel together in a single vehicle. Frequently, as riders remove their bicycles from transportation racks and lean them against the vehicle, not only access to the car is blocked, making difficult for one to retrieve his or her gear from the vehicle, but, expensive bicycles are knocked over, thus unnecessarily exposing the bikes to the risk of being damaged. Although free standing devices are available, they require a large footprint or must be staked into the ground. Particularly at bicycle races, these devices are undesirable options.

Therefore, in view of the above-noted brief summary of prior art devices and their associated limitations, a need exists for a hitch-mounted bicycle stand that will allow bikers to park their fully assembled bikes so as to minimize blocking access to their vehicle and to prevent unnecessary damage to the bicycles.

### SUMMARY OF THE INVENTION

In one preferred embodiment of the present invention, a hitch-mounted bicycle stand includes a base member, having a distal end portion adapted to be securely mounted on a hitch of a vehicle, and at least two vertically extending members attached to a proximal end portion of the base member, forming a slot configured to receive a portion of a bicycle tire for support.

In another embodiment of the instant invention, a bicycle stand includes a base member, having a distal end portion adapted to be securely mounted to a hitch-mounted transportation device, and vertically extending members attached to a proximal end portion of the base member, forming a slot to receive a portion of a bicycle tire for support.

In yet another embodiment of the invention, a hitch-mounted bicycle stand includes a base member, whose distal end portion is adapted to be securely mounted to a hitch of a vehicle, and bicycle standing means for receiving a portion of a bicycle tire and supporting a fully assembled bicycle near the vehicle, the bicycle standing means being disposed at a proximal end portion of the base member.

A method of standing a fully assembled bicycle next to a vehicle is also within the scope of the disclosed invention. The method includes the steps of inserting into a hitch of a vehicle a bicycle stand having a base member and at least one vertically members attached to a proximal end portion of the base member, the at least two vertically extending members being disposed separate from each other so as to form a slot there between to receive a portion of a bicycle tire for support, inserting into the slot of the bicycle stand the portion of the bicycle tire, and locking the bicycle tire inside the slot.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a schematic of one embodiment of the hitch-mounted bicycle stand of the invention;

FIG. 2 illustrates the bicycle stand of FIG. 1 in use;

FIG. 3 illustrates another embodiment of a hitch-mounted bicycle stand having multiple stand arms in one assembly;

FIG. 4 illustrates an insert to be used with the bicycle stand of FIG. 1 so as to make the height of the stand adjustable and to allow connection of the stand to a hitch-mounted bicycle transportation rack;

FIG. 5 illustrates an embodiment of an extender to be used with the bicycle stand of FIG. 1; and

FIG. 6 illustrates a schematic of a top view of an embodiment of a single width section of a stand slot of the bicycle stand of FIG. 1.

### DETAILED DESCRIPTION OF THE PREFERRED EMBODIMENTS

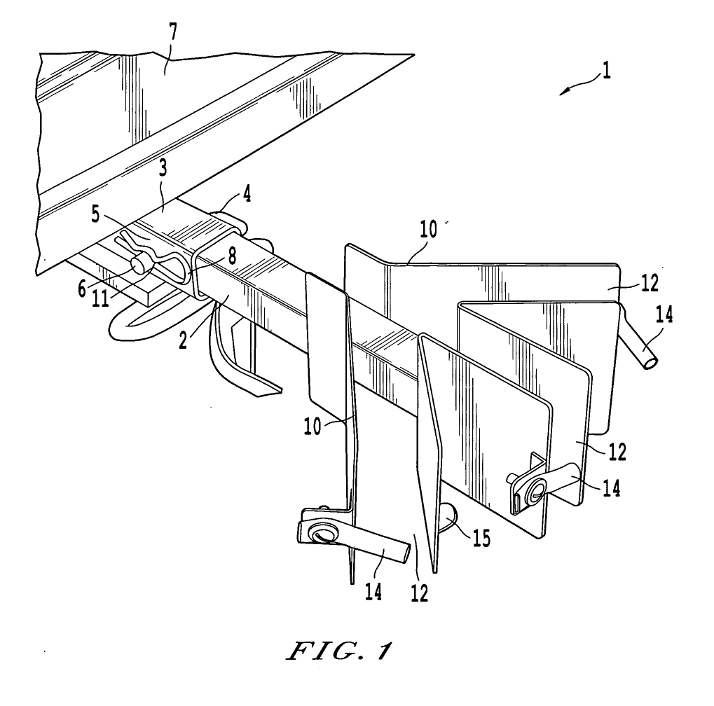

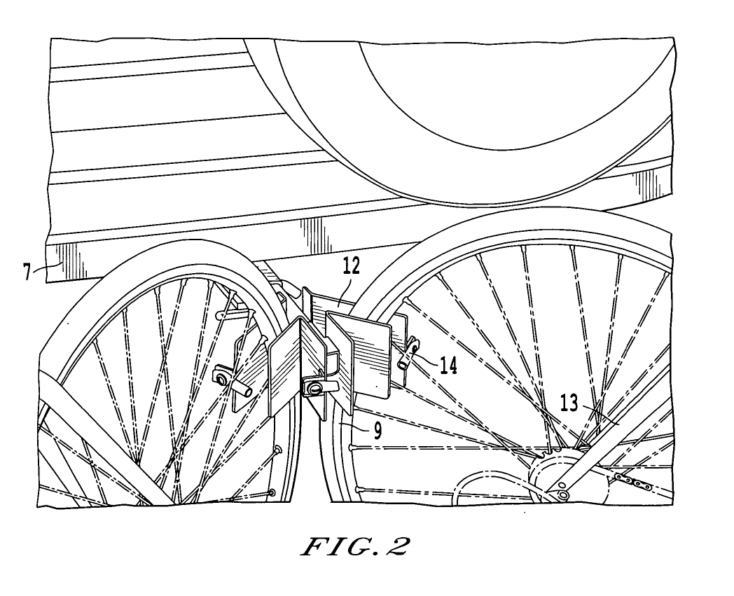

Referring now to the drawings, wherein like reference numerals designate identical or corresponding parts throughout the several views, FIG. 1 illustrates a schematic of a hitch-mounted bicycle stand 1 according to one of the preferred embodiments of the invention. As illustrated, the hitch-mounted bicycle stand 1 comprises a base member 2, to which a plurality of plates 10 are attached, forming slots 12. In use, the portion of a rear or front tire 9 of a fully assembled bicycle 13 (only partially illustrated in FIG. 2) is inserted in one of the slots 12 and locked by rotating lock 14 so as to prevent the bicycle tire 9 from leaving the slot 12, as illustrated in FIG. 2. The vertically extending walls of the slots 12 formed by the plates 10 provide the necessary support to keep the fully assembled bicycle standing on the ground. As such, the hitch-mounted bicycle stand 1 allows users access to the vehicle, by preventing blockage to the doors and tailgate, and minimizes damage to the bicycles by reducing the risk that the bicycles will be knocked down by people trying to gain access to the vehicle to retrieve gear or for any other purpose.

As illustrated in the figures, in one preferred embodiment, the base member 2 is tubular, having, as a non-limiting example, a square or rectangular cross section, and shaped so as to fit in a trailer hitch 3 of an automobile 7. The end of the base member 2, which is configured to be inserted into the trailer hitch 3, may comprise a plurality of spaced-apart transverse holes 4, a pair of which is configured to be attached to a pair of spaced-apart holes 5 in the trailer hitch 3. When inserted into position and aligned, a locking pin 6 is inserted through the aligned holes 4 and 5 in the trailer hitch and the base member 2, respectively, and a safety pin 8 is inserted through a hole 11 in the safety pin 8 so as to prevent the safety pin 8 from being removed. Although a locking pin 6 and safety pin 8 are shown, any know methods and devices capable of connecting the base member 2 to the trailer hitch 3 is within the scope of the disclosed invention.

As illustrated, each of the slots 12 of the bicycle stand 1 may also include a locking member 14, which may be rotatably attached to one of the plates 10 forming the slot. After the portion of the tire 9 of the bicycle 13 is inserted into the slot 12, the locking member 14 is rotated so as to prevent the bicycle 13 from coming off the bicycle stand 1. Although the locking member 14 has been illustrated as a solid piece rotatably connected to one of the plates 10 forming the slot 14, locking member 14 can also be an elastic member affixed to one of the plates 10. In use, once a bicycle 13 is inserted in a slot 12, the elastic locking member 14 is stretched across the slot 12 and held in place by a protrusion 15 in the opposite plate 10 of the slot 12, thus preventing the fully assembled bicycle 13 from coming off the stand 1.

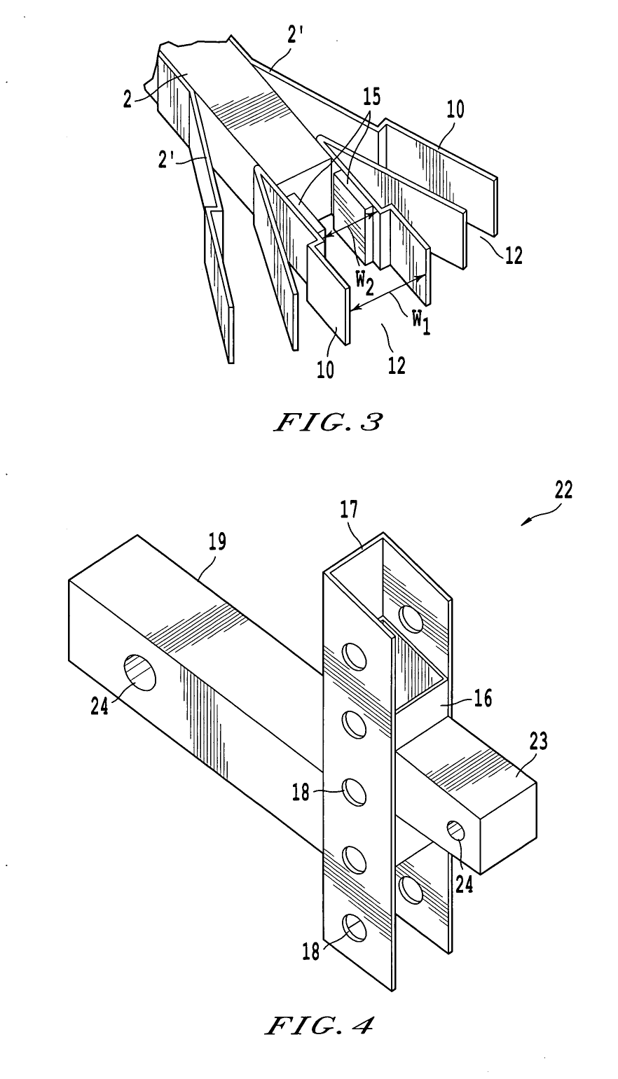

In another preferred embodiment, as illustrated in FIG. 3, the end of the base member 2 opposite to the one inserted into the trailer hitch 3 comprises a plurality of branches 2′, forming a fan assembly of stands. Each of the branches 2′ has a plurality of plates 10 attached thereto, forming slots 12. As such, the number of bicycles that can use the stand in one automobile hitch is increased. As also shown in FIG. 3, one or several of the slots in the fan assembly may be stepped in width in order to accommodate bicycle tires of different widths, i.e., w₁ or w₂, such as the tires of a mountain bicycle or a normal bicycles. In addition, one of several of the internal surfaces of the slots 12 may be covered with blocks 15 of a soft material in order to protect the tires and rims of the bicycles. In addition, the blocks 15 can be sized to provide significant friction on the tires in order to prevent rollaway when parked on sloping surfaces. In another embodiment, the stepped width can be eliminated, and a rack specifically for road bicycles or mountain bicycles can be employed by having slots of different widths. Additionally, the leaning internal surfaces of the slots 12 can be fabricated out or vinyl or rubber coated rods.

Another preferred embodiment of the invention is shown in FIG. 4, which illustrates an assembly 22 configured to adjust the height of the bicycle stand 1 (not shown) with respect to the vehicle 7 (not shown) as well as to install the bicycle stand 1 to an existing hitch-mounted bicycle transportion rack (not shown). In this embodiment, a tubular member 19 is used to mount the assembly 22 to the trailer hitch of the vehicle. The hitch end is drilled to enable a hitch pin (not shown) to be inserted through hole 24 just as if a ball hitch were inserted. At one end portion of the tubular member 19, a vertical channel 17 is provided with holes 18, in which a sliding member 16 is disposed. The vertical channel 17 is predrilled to enable height adjustment for the rack when used on vehicles with different ground clearances. As shown, the height of the sliding member 16 is adjustable by matching holes (not shown) in the sliding member 16 with a pair of holes 18 in the vertical channel 17. The bicycle stand 1 of FIG. 1 is then installed to the protruding element 23 of the sliding member 16 similar to the installation of the bicycle stand to a trailer hitch as previously explained. In another embodiment, rather than being predrilled, the channel 17 could be slotted, and the sliding member 16 could be threaded to provide continuous adjustment of height.

In another embodiment of the invention, the assembly illustrated in FIG. 4 may be installed to a connection of an existing hitch mounted bicycle transportion rack, thus also maintaining the variable height adjustment of that embodiment in connection with the transportion rack. One of the advantageous features of this embodiment is that a person is capable of standing bicycles removed from the transportation rack without removing the rack from the trailer hitch of the vehicle.

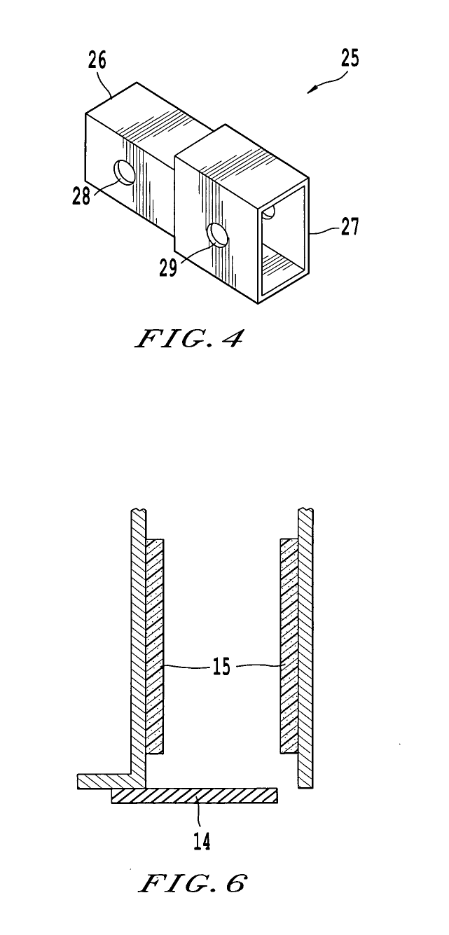

In yet another embodiment of the invention, an extender 25, as illustrated in FIG. 5, may be advantageously employed. Such an extender 25 may be used when the standard bicycle stand 1 is not long enough to enable hatches and doors to open freely when bicycles are racked, or when the vehicle has a rear mounted spare tire, which desirably needs to be cleared for proper use of the bicycle stand. In use, the bicycle stand 1 slides in to the large end 27 of the extender 25, and the small end 26 is inserted into the hitch receiver (not shown). Two hitch pins or bolts may be required in order to install both the bicycle stand 1 and the extender 15 via holes 29 and 28, respectively. In another embodiment, the extender 25 may actually be an adapter used to enable installation of the rack, or bicycle stand 1, designed for a small hitch to the larger dimensions required for the large size receiver. In yet another embodiment, the hitch extender principle can be used to attach other hardware which can be custom designed to attach the bicycle stand 1 to a trainer or to an existing travel rack already mounted in the receiver. The ability to do both may be advantageous at race sites.

FIG. 6 illustrated a top view of a single width section of the slot 12 of the bicycle stand 1 illustrated in FIG. 1. Blocks 15 are illustrated, and the locking member, or flexible gate, 14 is indicated as well. The gate provides resistance to rollaway when parked on a sloping surface. A variety of embodiments for preventing rollaway are possible, including, but not being limited to, a frictional foam pads, a flexible gate, a spring loaded gate, a swing gate, a hinged gate, a spring loaded pin, or a simple bungee style hook or gate.

Obviously, numerous modifications and variations of the disclosed inventions are possible in light of the above teachings. It is therefore to be understood that within the scope of the appended claims, the invention may be practiced otherwise than as specifically described herein.

What is claimed is:

1. A bicycle stand, comprising:
a base member, a proximal end portion of the base member being adapted to be mounted to a trailer hitch of a vehicle; and
at least two vertically extending members attached to a distal end portion of the base member, the at least two members forming a slot configured to receive a portion of a bicycle tire of an assembled bicycle for support.

2. The bicycle stand according to claim 1, wherein the at least two vertically extending members are the only portions of the bicycle stand supporting the assembled bicycle.

3. The bicycle stand according to claim 1, wherein the base member is tubular and shaped so as to fit in the trailer hitch, and comprises a portion having a plurality of spaced apart transverse holes configured to receive a locking pin inserted therethrough when connecting the base member to the trailer hitch.

4. The bicycle stand according to claim 1, wherein the at least two vertically extending members comprise first and second angled plate sections separated from each other so as to form the slot therebetween.

5. The bicycle stand according to claim 1, wherein the at least two vertically extending members comprise a plurality of first and second angled plate sections separated from each other in pairs so as to form the slot between each pair.

6. The bicycle stand according to claim 1, further comprising:
a locking member rotatably attached to the frame, the locking member being configured to be rotated when the portion of the bicycle tire is placed in the slot so as to prevent the assembled bicycle from coming off the bicycle stand.

7. The bicycle stand according to claim 6, wherein the locking member is at least one of an elastic locking member, a frictional foam pad, a flexible gate, a spring loaded gate, a swing gate, a hinged gate, a spring loaded pin, or a bungee hook.

8. The bicycle stand according to claim 1, wherein a height of at least a portion of the base member is adjustable with respect to the vehicle.

9. The bicycle stand according to claim 1, further comprising:
a plurality of extension members, wherein a proximal end portion of each extension member of the plurality is attached to the distal end portion of the base, and at least a pair of vertically extending members is attached to a distal end portion of each extension member of the plurality so as to form slots configured to receive portions of bicycle tires for support.

10. A bicycle stand, comprising:
a base member, a proximal end portion of the base member being adapted to be mounted to a hitch-mounted transportation rack; and
a frame member attached to a distal end portion of the base member, the frame member comprising a vertically extending slot configured to receive a portion of a bicycle tire of an assembled bicycle for support.

11. The bicycle stand according to claim 10, wherein the frame member is the only portion of the bicycle stand supporting the assembled bicycle.

12. The bicycle stand according to claim 10, wherein the base member is tubular and shaped so as to fit in the tubular member, and comprises a portion having a plurality of spaced apart transverse holes configured to receive a locking pin inserted therethrough when connecting the base member to the tubular member.

13. The bicycle stand according to claim 10, wherein the frame member comprises first and second angled plate sections separated from each other so as to form the slot therebetween.

14. The bicycle stand according to claim 10, wherein the frame member comprises a plurality of first and second angled plate sections separated from each other in pairs so as to form a plurality of slots between each pair.

15. The bicycle stand according to claim 10, further comprising:
a locking member rotatably attached to the frame member, the locking member being configured to be rotated when the portion of the bicycle tire is placed in the slot so as to prevent the assembled bicycle from coming off the bicycle stand.

16. The bicycle stand according to claim 15, wherein the locking member is at least one of an elastic locking member, a frictional foam pad, a flexible gate, a spring loaded gate, a swing gate, a hinged gate, a spring loaded pin, or a bungee hook.

17. The bicycle stand according to claim 10, wherein a height of at least a portion of the base member is adjustable with respect to the vehicle.

18. The bicycle stand according to claim 10, wherein the frame member comprises a plurality of frame members, each frame member of the plurality being attached to the distal end of the base member, and comprising a plurality of vertically extending first and second angled plate sections separated from each other in pairs so as to form a plurality of slots between each pair.

19. A hitch-mounted bicycle stand, comprising:
a base member, a proximal end portion of the base member being adapted to be mounted to a hitch of a vehicle; and
bicycle standing means for receiving a portion of a bicycle tire and supporting an assembled bicycle, the bicycle standing means being disposed at a distal end portion of the base member.

20. A bicycle stand, comprising:
a base member, a proximal end portion of the base member being adapted to be mounted to a hitch-mounted bike-transportation rack; and
bicycle standing means for receiving a portion of a bicycle tire and supporting an assembled bicycle, the bicycle standing means being disposed at a distal end portion of the base member.

21. A method of standing a bicycle next to a vehicle, comprising:
inserting into a hitch of the vehicle a bicycle stand comprising a base member, a proximal end portion of the base member being adapted to be mounted to the hitch of the vehicle, and at least two vertically extending members attached to a distal end portion of the base member, the at least two vertically extending members being disposed separate from each other so as to form a slot therebetween to receive a portion of a first bicycle tire for support;
inserting into the slot of the bicycle stand the portion of the first bicycle tire; and
locking the first bicycle tire of an assembled inside the slot.

22. The method according to claim 21, wherein the first tire and a second tire of the assembled bicycle are in contact with the ground.

23. The method according to claim 22, wherein the two vertically extending members are the only portions of the bicycle stand supporting the assembled bicycle on the ground.
